(19) United States
(12) Patent Application Publication
(10) Pub. No.: US 2025/0355446 A1
(43) Pub. Date: Nov. 20, 2025

(54) METHOD FOR DETERMINING A WORK ZONE FOR AN UNMANNED AUTONOMOUS VEHICLE

(71) Applicant: EEVE BV, Waregem (BE)

(72) Inventor: Wesley LORREZ, Waregem (BE)

(73) Assignee: EEVE BV, Waregem (BE)

(21) Appl. No.: 18/871,268

(22) PCT Filed: Jun. 8, 2023
(86) PCT No.: PCT/IB2023/055930

§ 371 Date: Dec. 3, 2024

(30) Foreign Application Priority Data
Jun. 9, 2022 (BE) 2022/5447

(51) Int. Cl. G05D 1/648; A01B 79/00; A01D 34/00; A01D 101/00; G05D 1/246; G05D 105/15; G05D 107/20

(52) U.S. Cl. CPC G05D 1/6482; A01B 79/005; G05D 1/2462; A01D 34/008; A01D 2101/00; G05D 2105/15; G05D 2107/23

(57) ABSTRACT

The present invention relates to a method for determining a work zone for an unmanned autonomous vehicle, comprising determining a set of points within the work zone, with the vehicle capturing at least one image of a ground at each point, and determining classifications for ground types, exploration by the vehicle of a contiguous part of the terrain up to a perimeter, starting from a point within the contiguous part, wherein an obstacle or a transition to a different ground type is part of the perimeter, wherein the vehicle determines a position during exploration, repeating the previous step from a next point, where the next point is not in an already explored part, and creating a map of the work zone, corresponding to the explored parts, based on the determined positions. The invention also relates to an unmanned autonomous vehicle and a use.

### TECHNICAL FIELD

The invention relates to a method for determining a work zone for an unmanned autonomous vehicle in a terrain.

### PRIOR ART

Unmanned autonomous vehicles are known from the prior art. These are used, for example, as robotic lawnmowers or as robotic vacuum cleaners. Traditionally, robotic lawnmowers have a cable with a signal buried around the area to be mowed or a fence has been placed around the area to be mowed. Robotic vacuum cleaners are restricted in their movement by walls. Restricting the freedom of movement of a robotic lawnmower or a robotic vacuum cleaner therefore requires an infrastructural boundary, which means that such robots cannot be deployed quickly. It is also disadvantageous that if only part of a terrain may be mowed or a part of a space may be vacuumed, or if a terrain or space changes, the infrastructural boundary must be adapted. There is therefore a need for a flexible solution for determining a work zone for an unmanned autonomous vehicle in a terrain, without the need for infrastructural boundaries.

Such a method is known, inter alia, from EP 2 884 364 (EP '364).

EP '364 describes a method in which an autonomous gardening vehicle is moved through a terrain, while the vehicle simultaneously takes series of images of sections of the terrain. Simultaneously with the movement of the autonomous vehicle, an algorithm for locating the autonomous vehicle and for mapping the terrain is executed, generating terrain data from the series of images. A work zone is defined by moving the autonomous vehicle along a perimeter of the work zone.

This method has the drawback that, despite the fact that no infrastructural boundary is necessary, putting the autonomous vehicle into service takes a lot of time. The autonomous vehicle must be moved over the entire terrain before a map of the terrain is available and the autonomous vehicle can navigate autonomously effectively. Determining the work zone requires an additional step of moving the autonomous vehicle along the perimeter of the work zone. Determining the work zone requires a lot of time and a lot of interaction with a user of the autonomous vehicle.

U.S. Pat. No. 11,037,320 (US '320) describes a method in which an autonomous vehicle autonomously explores an environment. The autonomous vehicle maps the environment in this process. The method according to US '320 has the disadvantage that only a clearly defined environment can be explored autonomously.

The present invention aims to solve at least some of the above problems or drawbacks.

### SUMMARY OF THE INVENTION

In a first aspect, the present invention relates to a method according to claim 1.

This method has the advantage that by determining a set of at least one point, where each point from the set lies within the work zone to be determined, the unmanned autonomous vehicle autonomously explores contiguous parts of the terrain, without requiring time from a user of the unmanned autonomous vehicle or further interaction with that user or without requiring infrastructural boundaries. The unmanned autonomous vehicle will autonomously explore the entire contiguous part of the terrain in which the mentioned point is located, starting from a point in the set of at least one point, while the unmanned autonomous vehicle remains within a perimeter of the contiguous part. The unmanned autonomous vehicle considers an obstacle or a transition to a ground type, which is different from the ground type for the ground at the mentioned point from the set of at least one point, as part of the perimeter. As a result, the user of the unmanned autonomous vehicle does not have to determine the perimeter of the contiguous part of the terrain themselves. An additional advantage is that the unmanned autonomous vehicle repeats the step of autonomously exploring a contiguous part of the terrain, until every point from the set of at least one point is located in a contiguous part of the terrain that has been autonomously explored. This allows the unmanned autonomous vehicle to autonomously explore contiguous parts of the terrain that are not adjacent and/or adjacent contiguous parts of the terrain with different ground types. The work zone corresponds to the autonomously explored contiguous parts of the terrain. The method therefore allows even complex work zones to be determined for the unmanned autonomous vehicle.

Preferred embodiments of the method are set out in claims 2-13.

A specific preferred form concerns a method according to claim 7.

This preferred form allows to determine the set of at least one point in a very simple way. A user of the unmanned autonomous vehicle can do this by moving the unmanned autonomous vehicle through the various contiguous parts that define the work zone. The user does not have to move the unmanned autonomous vehicle through the entire contiguous part for any of the contiguous parts that define the work zone, nor along a perimeter of the contiguous part, saving the user a lot of time. The user also does not have to define coordinates for these points.

In a second aspect, the present invention relates to an unmanned autonomous vehicle according to claim 14.

Such an unmanned autonomous vehicle is advantageous because, after minimal effort by a user of the unmanned autonomous vehicle and without the use of infrastructural boundaries, it is suitable for determining a work zone for the unmanned autonomous vehicle in a terrain.

In a third aspect, the present invention relates to a use according to claim 15.

This use results in a simplified determination of a work zone for an unmanned autonomous vehicle in a terrain, where a user of the unmanned autonomous vehicle determines a part of the terrain as work zone with minimal effort and without using infrastructural boundaries, allowing the unmanned autonomous vehicle to autonomously maintain the garden within the work zone.

### DESCRIPTION OF THE FIGURES

FIG. 1 shows a block diagram of a method according to an embodiment of the present invention.

FIG. 2 shows a schematic representation of a terrain with various contiguous parts.

FIG. 3 shows a schematic representation of determining a set of points within a work zone in a terrain with various contiguous parts, according to an embodiment of the current invention.

FIG. 4 shows a schematic representation of the autonomous exploration of a terrain with various contiguous parts, according to an embodiment of the current invention.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise,” “comprising,” “consist of,” “consisting of,” “provided with,” “include,” “including,” “contain,” “containing,” are synonyms and are inclusive or open terms that indicate the presence of what follows, and which do not exclude or prevent the presence of other components, characteristics, elements, members, steps, as known from or disclosed in the prior art.

A contiguous part of a terrain is a part of the terrain where the same classification for a ground type of a ground is determined at all positions in the contiguous part of the terrain, and where any arbitrary first position in the contiguous part of the terrain can be reached from any arbitrary second position in the contiguous part of the terrain, without entering a part of the terrain that does not belong to the contiguous part of the terrain.

Quoting numerical intervals by endpoints comprises all integers, fractions and/or real numbers between the endpoints, these endpoints included.

In the context of this document, a neural network means an artificial neural network, where the neural network comprises inputs, nodes, called neurons, and outputs. An input is connected to one or more neurons. An output is also connected to one or more neurons. A neuron can be connected to one or more neurons. A neural network can comprise one or more layers of neurons between an input and an output. Each neuron and each connection of a neural network typically has a weight that is adjusted during a training phase using a training set of sample data.

In a first aspect, the invention relates to a method for determining a work zone for an unmanned autonomous vehicle in a terrain.

According to a preferred embodiment, the method comprises the steps of:
determining a set of at least one point, each point of the set being located within the work zone to be determined in the terrain;
autonomous exploration by the unmanned autonomous vehicle of a contiguous part of the terrain, where the unmanned autonomous vehicle departs from a point in the set of at least one point within the contiguous part of the terrain;
repeating the previous step from a next point in the set of at least one point, where the next point is not located in a contiguous part of the terrain that has already been explored autonomously;
creating a map of the work zone.

The unmanned autonomous vehicle comprises a drive unit for moving the unmanned autonomous vehicle across the terrain, a camera for capturing images of the terrain, a positioning means for determining a position of the unmanned autonomous vehicle on the terrain, and a memory and processor.

The drive unit comprises at least one wheel and a motor for driving the wheel. Preferably, the motor is an electric motor. Preferably, the unmanned autonomous vehicle comprises a battery for powering the motor and other electrical systems. It will be apparent to one skilled in the art that the unmanned autonomous vehicle may comprise two, three, four or more wheels, wherein at least one wheel, preferably at least two wheels, are coupled to the motor for driving. It will be apparent to one skilled in the art that the at least one wheel can be part of a caterpillar track, the caterpillar track being drivable by the motor by means of the at least one wheel. The unmanned autonomous vehicle comprises a steering device for steering the unmanned autonomous vehicle. The steering device is a conventional steering device in which at least one wheel is rotatably arranged. Alternatively, the steering device is part of the drive unit, wherein two wheels on opposite sides of the unmanned autonomous vehicle can be driven differently by the motor. Differently means with a different speed and/or opposite direction of rotation. The steering device may or may not be part of the drive unit.

The camera is a digital camera. The camera is at least suitable for taking two-dimensional images. Optionally, the camera is suitable for taking three-dimensional images, with or without depth determination. The camera has a field of view that comprises at least a part of a ground of the terrain at a distance of at most 2 m from the unmanned autonomous vehicle, preferably at most 1 m, more preferably at most 0.5 m. This is advantageous for capturing images of a ground of the terrain at a position of the unmanned autonomous vehicle in the terrain. The camera has a known alignment on the unmanned autonomous vehicle, the alignment being preferably in a direction of forward movement of the unmanned autonomous vehicle. This is advantageous because during forward movement, the ground of the terrain towards which the unmanned autonomous vehicle is moving falls into the field of view of the camera. Optionally, the unmanned autonomous vehicle comprises a second camera of known alignment, the alignment of the camera preferably being in a direction of backward movement of the unmanned autonomous vehicle. This is advantageous because during backward movement, the ground of the terrain towards which the unmanned autonomous vehicle is moving falls into the field of view of the second camera. Alternatively, the camera is arranged rotatably. This is advantageous because, due to the rotation of the camera, both during forward and backward movement, the ground of the terrain towards which the unmanned autonomous vehicle is moving falls within the camera's field of view, while only a single camera is required. Optionally, the camera is also suitable for capturing images with non-visible light, such as infrared light or ultraviolet light. This is advantageous because it allows images of the terrain to be captured with visible light, infrared light, and ultraviolet light, from which different information can be obtained, which can be advantageously combined for a successful classification of a ground type of a ground of the terrain visible in a captured image. It will be apparent to one skilled in the art that instead of a single camera, various cameras can also be combined, for example, wherein a first camera captures images using visible light, a second camera captures images using infrared light, and a third camera captures images using ultraviolet light. Preferably, the first camera, the second camera, and the third camera have an overlapping field of view. This is advantageous for combining information from images captured using the first camera, the second camera, and the third camera. It will be apparent to one skilled in the art that the unmanned autonomous vehicle can comprise several similar cameras.

The positioning means for determining the position of the unmanned autonomous vehicle on the terrain can be any suitable means. The positioning means is, for example, a Global Navigation Satellite System (GNSS), such as GPS, GLONASS or Galileo. The positioning means is, for example, a system with wireless beacons on the terrain, whereby the unmanned autonomous vehicle determines a position on the terrain by triangulation. The positioning means is, for example, based on recognition of reference points in images of the terrain, for example images made with the aid of the camera of the unmanned autonomous vehicle. In the latter case, in addition to a known alignment, the camera also has a known position and viewing angle. Knowing the viewing angle of the camera and the position and the alignment of the camera on the unmanned autonomous vehicle, it is possible by means of trigonometry and/or photogrammetry to automatically estimate a distance from a reference point in an image to the camera and the unmanned autonomous vehicle, a distance between two reference points in an image and/or a dimension of a reference point in an image, even if the camera is only suitable for taking two-dimensional images, so that the position of the unmanned autonomous vehicle on the terrain can be determined. In the case of a rotatable camera, the camera is preferably rotatable 360° in a horizontal plane and rotatable 180° in a vertical plane. The rotatable arrangement of the camera is preferably drivably coupled to motors with encoders. Motors with encoders are advantageous for knowing the position and alignment of a rotatably mounted camera.

Each point in the set of at least one point is characterized by coordinates that determine the position of the point in the terrain. The coordinates can be geographic coordinates that numerically record a position on Earth with a latitude, a longitude, and optionally an altitude, for example using a GNSS. The coordinates can be relative coordinates, which define a position in the terrain relative to fixed reference points in the terrain, for example, distances from wireless beacons in the terrain or distances relative to visual reference points.

For each point in the set of at least one point, at least one image of a ground of a terrain at the said point is captured. The at least one image is captured using a digital camera, for example using a digital single-lens reflex camera, with a built-in camera of a smartphone or with the camera of the unmanned autonomous vehicle. Ideally, at least one image is captured using the camera of the unmanned autonomous vehicle. This is advantageous because no additional camera is required for carrying out the method. This is additionally advantageous because it guarantees that the image of the ground on the terrain at the said point is captured from the same viewing angle, which is advantageous during the autonomous exploration by the unmanned autonomous vehicle, as will be apparent from the further description of the method.

Classifications are determined for ground types of the grounds in the captured images. A classification can be binary, for example a ground type is grass (1) or is not grass (0) or can also be a value that represents a probability, for example a ground type with 83% probability of grass. In the context of this document, a positive classification refers to a classification with a probability greater than 60%, preferably greater than 75%, more preferably greater than 90%, and even more preferably greater than 98%. It will be apparent to one skilled in the art that in a binary system, a value of 1 is a positive classification and a value of 0 is not a positive classification. Non-limiting examples of classifications are grass, gravel, stone floor, soil, flower bed, leaves, parquet, vegetable garden, etc. Classifications for the ground types of the grounds in the captured images are stored in the unmanned autonomous vehicle. The unmanned autonomous vehicle comprises a memory for this purpose.

During the autonomous exploration of a contiguous part of the terrain, the unmanned autonomous vehicle remains within a perimeter of the contiguous part of the terrain. As a result, the unmanned autonomous vehicle remains in the contiguous part of the terrain during autonomous exploration. The unmanned autonomous vehicle considers an obstacle as part of the perimeter of the contiguous part of the terrain. Non-limiting examples of obstacles are a garden wall, a fence, a canal, etc. The unmanned autonomous vehicle does not move over or through the obstacle. The unmanned autonomous vehicle considers a transition to a ground type, which is different from the ground type for the ground at the mentioned point from the set of at least one point, as part of the perimeter. The mentioned point is the point from the set of at least one point within the contiguous part of the terrain from where the unmanned autonomous vehicle has departed for autonomously exploring the contiguous part of the terrain. The unmanned autonomous vehicle captures images of a ground in the contiguous part of the terrain while autonomously exploring the contiguous part of the terrain using the camera of the unmanned autonomous vehicle. The unmanned autonomous vehicle determines a classification for ground types of the grounds in the images captured during autonomous exploration. The unmanned autonomous vehicle comprises a processor and memory for this purpose. If the classification for the ground type of the ground in a captured image captured during autonomous exploration is different from the classification for the ground type of the ground in an image captured during the determination of the set of at least one point for the said point, then there is a transition to a ground type, which is different from the ground type for the ground at the said point. In the case where a classification represents a probability, a different classification means that no same positive classification has been obtained. It will be apparent that for determining a transition between ground types, it is advantageous for images to be captured from the same viewing angle relative to the unmanned autonomous vehicle, consequently also during the step of determining the set of at least one point. The unmanned autonomous vehicle does not move past the said transition. Because the unmanned autonomous vehicle does not move over or through an obstacle or beyond the said transition, the user of the unmanned autonomous vehicle does not have to determine the perimeter of the contiguous part of the terrain themselves. It will be apparent from the description that the contiguous part of the terrain consists of a single ground type. For example, the contiguous part of the terrain is a lawn, a terrace, a vegetable garden, etc.

The autonomous exploration of the contiguous part of the terrain is particularly advantageous because it does not require any time from a user of the unmanned autonomous vehicle or further interaction with this user, nor does it require any infrastructural boundaries. The unmanned autonomous vehicle autonomously fully explores the contiguous part of the terrain. A contiguous part of the terrain has been fully explored if the unmanned autonomous vehicle, after a map of the work zone has been determined, can autonomously determine with the aid of said map whether the unmanned autonomous vehicle is within the contiguous part and preferably also where it is located within the contiguous part. For this purpose, the unmanned autonomous vehicle must determine at least the entire perimeter of the contiguous part of the terrain.

The unmanned autonomous vehicle, while autonomously exploring the contiguous part of the terrain, determines a position of the unmanned autonomous vehicle on the terrain using the positioning means. The determined positions are stored in the unmanned autonomous vehicle.

It is possible from the autonomous exploration of the contiguous part that several points from the set of at least one point lie in the contiguous part. By repeating the autonomous exploration step for a next point from the set of at least one point, where the next point is not located in a contiguous part of the terrain that has already been explored autonomously, it is ensured that all different contiguous parts of the terrain that lies in the work zone to be determined, can be explored autonomously by the unmanned autonomous vehicle. This allows the unmanned autonomous vehicle to autonomously explore contiguous parts of the terrain that are not adjacent and/or adjacent contiguous parts of the terrain with different ground types.

The work zone map is created based on the determined positions of the unmanned autonomous vehicle. The positions of the unmanned autonomous vehicle in the autonomously explored contiguous parts of the terrain determine a zone in which the unmanned autonomous vehicle is allowed to perform tasks and navigate, in other words the work zone. The work zone corresponds to the autonomously explored contiguous parts of the terrain. As a result, the method makes it possible to determine even complex work zones for the unmanned autonomous vehicle, for instance with non-adjacent contiguous parts of the terrain and/or with adjacent contiguous parts of the terrain with different ground types.

According to an alternative embodiment, for each point from the set of at least one point, at least one image is selected from a database of existing images. The at least one image from the database of existing images is an image of a ground that corresponds to the ground of the terrain at the said point. For example, an image of grass is selected if the ground of the terrain at said point is in a lawn. Selecting at least one image from the database of existing images is an alternative to capturing at least one image of the ground of the terrain at the mentioned point. This embodiment is advantageous if a user does not have a camera available or if the unmanned autonomous vehicle is not equipped with a camera. This embodiment is advantageous if grounds in the terrain correspond to standard ground types that occur in images in the database of existing images.

According to a further embodiment, the set of at least one point consists of a single point. The single point is determined by placing the unmanned autonomous vehicle in the terrain. The point where the unmanned autonomous vehicle is placed in the terrain is the single point of the set of at least one point. This embodiment is particularly advantageous if the work zone corresponds to a single contiguous part of the terrain where the soil in the contiguous part of the terrain has a ground type that corresponds to a standard ground type found in an image in the database of existing images. For example, the work zone is a lawn that forms a contiguous part of the terrain. By placing the unmanned autonomous vehicle on the lawn and selecting an image from the database of existing images of a lawn, the unmanned autonomous vehicle is ready for the step of autonomously exploring the lawn without additional steps by a user.

According to an embodiment, the images captured during the step of determining a set of at least one point are stored on a server via a data connection, preferably a wireless data connection. The classifications for the ground types of the grounds in the captured images are determined on the server. The server is either a local server or a server in the cloud. The wireless data connection is a Wi-Fi connection or a data connection over a mobile network, such as 5G.

This embodiment is advantageous because a server has sufficient storage and computing power to determine the classifications for the ground types of the grounds in the captured images.

According to an embodiment, the images captured during the step of determining a set of at least one point are captured using the camera of the unmanned autonomous vehicle and stored in a memory of the unmanned autonomous vehicle. The classifications for the ground types of the grounds in the captured images are determined in the unmanned autonomous vehicle. As previously described, the unmanned autonomous vehicle comprises a processor and memory for this purpose.

This embodiment is advantageous in that because the images can be captured and saved during the step of determining a set of at least one point and can be processed for determining the classifications for the ground types of the grounds in the captured images, even if the unmanned autonomous vehicle has no data connection. Sending the captured images over a data connection, in particular a data connection over a mobile network, can require a lot of data depending on the size of the set of at least one point and can be expensive depending on a type of subscription.

According to an embodiment, the work zone map is created on a server. The determined positions of the unmanned autonomous vehicle during the autonomous exploration step are forwarded to the server for this purpose via a data connection, preferably a wireless data connection. The map created is forwarded to the unmanned autonomous vehicle via a data connection, preferably the same data connection. The server is either a local server or a server in the cloud. The wireless data connection is a Wi-Fi connection or a data connection over a mobile network, such as 5G.

This embodiment is advantageous because a server has sufficient storage and computing power to create the map.

According to an embodiment, the work zone map is created in the unmanned autonomous vehicle. The unmanned autonomous vehicle comprises a processor and memory for this purpose. Preferably, this is the same processor and memory as in previously described embodiments.

This embodiment is advantageous because the map can be created even if the unmanned autonomous vehicle has no data connection. Sending the determined positions of the unmanned autonomous vehicle during the autonomous exploration step via a data connection, in particular a data connection via a mobile network, may require a lot of data depending on the size of the autonomously explored contiguous parts of the terrain and be expensive depending on the type of subscription.

According to an embodiment, at least one additional point is added to the set of at least one point, preferably at least two additional points, more preferably at least three additional points, even more preferably at least four additional points and even more preferably at least five additional points. The additional points are preferably added to the set of at least one point during the step of determining the set of at least one point. Each additional point added to the set of at least one point is in an additional contiguous part of the terrain where no other point, already belonging to the set of at least one point, is in the additional contiguous part of the terrain. After the additional point has been added to the set of at least one point, further points can be added to the set of at least one point that are located in the additional contiguous part of the terrain. For example, by adding at least two additional points, two additional contiguous parts of the terrain, which are not adjacent and/or have a different ground type, will be explored autonomously by the unmanned autonomous vehicle. This embodiment is advantageous for defining a complex work zone, which comprises several contiguous parts of the terrain, which are not adjacent and/or have a different ground type.

According to a preferred embodiment, the method comprises the additional step of determining a coordinate of a first end point and a coordinate of a second end point. The coordinates determine a position of the first end point and the second end point in the terrain. The coordinates can be geographic coordinates or relative coordinates as previously described. The first end point and the second end point define a line that is considered part of the perimeter of the contiguous part by the unmanned autonomous vehicle while autonomously exploring a contiguous part of the terrain. The unmanned autonomous vehicle does not move beyond the said line. This embodiment is advantageous if a user wishes to reduce the work zone so that at least one contiguous part of the terrain falls partly outside the work zone. For example, because a user does not want a lawn to be completely mowed by the unmanned autonomous vehicle.

According to a further embodiment, the coordinates of the first end point and the second end point are determined by drawing a line on a digital map of the terrain. The digital map is a graphic representation of the terrain, for example a satellite photo. For this purpose, the digital map is preferably displayed on a smartphone, a tablet or on a computer screen. The position of the first end point and the second end point on the digital map is converted to coordinates of the first end point and the second end point. The coordinates of the first end point and the second end point are loaded into the unmanned autonomous vehicle, for example by means of a data carrier such as a USB stick, a wired connection such as a USB cable or a wireless connection such as a WiFi connection or a data connection over a mobile network, such as 5G. Preferably, the coordinates of the first end point and the second end point are loaded into the unmanned autonomous vehicle via a wireless connection. The coordinates of the first end point and the second end point are preferably stored in memory of the unmanned autonomous vehicle. This embodiment is advantageous because it allows a user of the unmanned autonomous vehicle to determine the line in a simple and visual manner, without having to determine or calculate the exact coordinates of the first end point and the second end point themselves.

According to a preferred embodiment, the unmanned autonomous vehicle dynamically adjusts the work zone map on the basis of identified obstacles and/or on the basis of a changed ground type within the work zone.

The identified obstacles and/or the changed ground type within the work zone are, as previously described, considered by the unmanned autonomous vehicle as a perimeter, which the unmanned autonomous vehicle does not move over, through or past. The perimeter is automatically added to the work zone map. Adjustment of the map is done automatically without the intervention of a user of the unmanned autonomous vehicle. A user does not have to add the identified obstacles and/or changed ground types to the map or initiate an action to adjust the created map of the work zone. This embodiment is advantageous because, for example, after the creation of a flower bed in a lawn, whether or not at the edge of the lawn, the created work zone map is automatically adapted, allowing the unmanned autonomous vehicle to take into account the adjusted map when performing a task within the work zone. For example, when mowing the lawn, the flower bed will automatically not be mowed, because the flower bed is no longer part of the work zone. Preferably, identified obstacles and/or changed ground types are also automatically removed from the created map if a previously identified obstacle and/or changed ground type is no longer present, for example because a flower bed has been sown as a lawn.

According to a preferred embodiment the unmanned autonomous vehicle determines classifications for ground types of grounds on the terrain using a neural network. The neural network was trained using a training set with images of different grounds. The training set can be a global training set, where the global training set includes images of grounds in other terrains. This is advantageous because the neural network can be trained in advance and the unmanned autonomous vehicle can be deployed immediately on the terrain. The training set can be a local training set, where the local training set only comprises images of grounds on the terrain in which the work zone to be determined is located. A local training set is disadvantageous compared to a global training set, because an extensive local training set must first be created, after which the neural network can be trained and only then can the unmanned autonomous vehicle be deployed on the terrain. A local training set is advantageous over a global training set because the neural network can be trained specifically for the terrain, potentially leading to better classifications. The training set can be a global training set, which is extended with a local training set. This is advantageous because a more limited local training set can be collected, so that the unmanned autonomous vehicle can be deployed more quickly compared to only a local training set, while possibly still achieving a better classification compared to only a global training set. A neural network is very suitable for identifying similar structures in grounds, enabling an accurate classification of ground types and a good determination of the work zone.

According to a preferred embodiment the map of the work zone is created while the unmanned autonomous vehicle is being charged at a charging station. The unmanned autonomous vehicle is connected to the charging station by means of an electrical cable or electrical contacts. Alternatively, the unmanned autonomous vehicle is wirelessly charged by the charging station. Creating the work zone map is a computationally intensive task that requires a lot of power. By creating the map of the work zone while the unmanned autonomous vehicle is being charged, it is avoided that during processing, for example, the battery of the unmanned autonomous vehicle reaches a critical level or becomes exhausted, thus ending the creation of the map of the work zone prematurely and any intermediate results will be lost.

According to a preferred embodiment, the set of at least one point is determined by designating the at least one point on a digital map of the terrain. The digital map is a graphic representation of the terrain, for example a satellite photo. For this purpose, the digital map is preferably displayed on a smartphone, a tablet or on a computer screen. The position of the at least one point on the digital map is converted into coordinates of the at least one point. The coordinates of at least one point are loaded into the unmanned autonomous vehicle, for example by means of a data carrier such as a USB stick, a wired connection such as a USB cable or a wireless connection such as a WiFi connection or a data connection over a mobile network, such as 5G. Preferably, the coordinates of the at least one point are loaded into the unmanned autonomous vehicle via a wireless connection. The coordinates of the at least one point are preferably stored in the memory of the unmanned autonomous vehicle. This embodiment is advantageous because it allows a user of the unmanned autonomous vehicle to determine the at least one point in a simple and visual manner, without having to determine or calculate the exact coordinates of the at least one point themselves.

According to a preferred embodiment the set of at least one point is determined by moving the unmanned autonomous vehicle along a route. The unmanned autonomous vehicle is only moved over parts of the terrain that are part of the work zone to be determined. A point is added to the set of at least one point by using the positioning means to determine a position of the unmanned autonomous vehicle on the terrain and at the same time taking at least one image of a ground of the terrain using the camera of the unmanned autonomous vehicle at the specified position. As a result, the coordinates of the point are determined and it is possible to determine a classification for a ground at a position of the point in the terrain.

The unmanned autonomous vehicle automatically adds a point to the set of at least one point at regular intervals. Adding a point is as per previously described embodiments. The scheduled times are determined in such a way that the unmanned autonomous vehicle has moved over a distance of at most 5 m between the addition of two different points, preferably at most 4 m, more preferably at most 3 m, even more preferably at most 2 m, even more preferably at most 1 m and even more preferably at most 0.5 m. It will be apparent to one skilled in the art that the speed of recording points depends on a speed at which the unmanned autonomous vehicle is moved along the route.

This preferred form is advantageous to determine the set of at least one point in a very simple way. A user of the unmanned autonomous vehicle can do this by moving the unmanned autonomous vehicle through the various contiguous parts that define the work zone. The user does not have to move the unmanned autonomous vehicle through the entire contiguous part for any of the contiguous parts that define the work zone, nor along a perimeter of the contiguous part, saving the user a lot of time. The user also does not have to define coordinates for these points. This is particularly advantageous as interpreting a map is difficult for some users.

According to a further embodiment, the unmanned autonomous vehicle is pulled or pushed by a person while moving along the route. This embodiment is advantageous because the unmanned autonomous vehicle need have only minimal facilities to be moved along the route.

According to an alternative embodiment, the unmanned autonomous vehicle is moved by a person with the aid of a control while moving along the route. The control is preferably a remote control. The remote control is wired or wireless. The remote control is preferably wireless. This embodiment is advantageous because a person does not have to make strenuous physical efforts such as pulling or pushing the unmanned autonomous vehicle.

According to a preferred alternative embodiment, the unmanned autonomous vehicle is moved along the route by following a person. The unmanned autonomous vehicle uses the camera to record images of the person. The person is recognized in the captured images and followed by the unmanned autonomous vehicle through the use of image recognition. The unmanned autonomous vehicle uses the drive unit and steering device to keep the person visible to the camera and at an equal distance.

Preferably, the unmanned autonomous vehicle is configured to keep the person at a distance of at least 1 m and at most 5 m.

Preferably, the unmanned autonomous vehicle is configured to keep the person at a distance of at least 1.5 m, more preferably at least 2 m and even more preferably at least 2.5 m.

Preferably, the unmanned autonomous vehicle is configured to hold the person at a distance of at most 4 m, more preferably at most 3.5 m and even more preferably at most 3.25 m.

Within these distances, a person is far enough away from the camera for the camera to have a sufficient view of the terrain. On the other hand, the person is close enough to the camera so that the person can easily and successfully be recognized and followed by the unmanned autonomous vehicle.

This embodiment is advantageous because moving the unmanned autonomous vehicle requires minimal effort on the part of the person. The route only needs to be walked once by the person in order for the unmanned autonomous vehicle to further explore contiguous parts of the terrain fully autonomously and then to create a map of the work zone. The unmanned autonomous vehicle does not have to be physically moved by the person themselves or controlled with the aid of a control, whether or not remotely. Driving an unmanned autonomous vehicle with a control requires a large learning curve, while after creating the work zone map, manually operating the unmanned autonomous vehicle is no longer necessary.

It will be apparent to one skilled in the art that an unmanned autonomous vehicle may be suitable for being moved along the perimeter in the terrain according to any of the previously described embodiments.

According to a preferred embodiment, the closed route is a closed route. This means that the route starts and arrives at the same position in the terrain. The unmanned autonomous vehicle will automatically start the autonomous exploration step after the route is closed. This is advantageous because it means that a user does not have to initiate the autonomous exploration and fewer actions are required from the user of the unmanned autonomous vehicle. Preferably, said position is a position where a charging station for the unmanned autonomous vehicle is placed. The charging station has a known shape that can be recognized by the unmanned autonomous vehicle, so that the unmanned autonomous vehicle knows that the route has been closed.

According to a preferred embodiment, the unmanned autonomous vehicle creates a map of the route after determining the set of at least one point. The map of the route allows the unmanned autonomous vehicle to navigate autonomously along the route. This is advantageous because, thanks to the map of the route, when navigating autonomously within contiguous parts of the terrain, the unmanned autonomous vehicle knows when it is on the route and therefore also knows which points of the route are in an already autonomously explored contiguous part of the terrain. The map of the route is additionally advantageous because thanks to the map of the rout, the unmanned autonomous vehicle can navigate autonomously to a next point on the route that is not located in a contiguous part of the terrain that has already been explored autonomously.

According to a preferred embodiment, the positioning means uses a Global Navigation Satellite System. This is advantageous because it allows a position of the unmanned autonomous vehicle in the terrain to be determined without infrastructural elements. According to a preferred embodiment, the positioning means uses the camera of the unmanned autonomous vehicle. As previously described, the camera is at least suitable for making two-dimensional images and the camera is optionally suitable for making three-dimensional images, with or without depth determination. The positioning means is, for example, based on recognition of reference points in images of the terrain made with the aid of the camera of the unmanned autonomous vehicle. By means of trigonometry and/or photogrammetry it is possible to automatically estimate a distance from a reference point in an image to the camera and the unmanned autonomous vehicle, a distance between two reference points in an image and/or a dimension of a reference point in an image. This embodiment can be combined with a previously described embodiment in which the positioning means uses a Global Navigation Satellite System to reduce errors on coordinates determined with the Global Navigation Satellite System. However, the positioning means can also only use the camera of the unmanned autonomous vehicle, so that the unmanned autonomous vehicle is not dependent on any satellite reception.

According to an embodiment, the method comprises the additional step of assigning a task to each of the autonomously explored contiguous parts within the work zone. Non-limiting examples of tasks that can be performed in an autonomously explored contiguous part within the work zone are mowing, vacuuming, sweeping, spraying, pruning, etc. Several tasks can be assigned to an autonomously explored contiguous part within the work zone. The same or different tasks can be assigned to different autonomously explored contiguous parts. For example, a contiguous part consisting of grass can be assigned the task of mowing the grass, while a contiguous part consisting of the terrace can be assigned the task of sweeping the terrace. Both contiguous parts could be assigned the task of removing leaves. It will be apparent that these assigned tasks can be changed afterwards or that tasks can be assigned, for example, based on a time, time period, date, or season.

This embodiment is advantageous because the method now not only allows a simple determination of a work zone, but also a simple determination of which task or tasks the unmanned autonomous vehicle must perform in the work zone. It is particularly advantageous that it is possible, depending on where the unmanned autonomous vehicle is located, i.e., in which contiguous part of the terrain, to have the unmanned autonomous vehicle perform a different task.

According to an embodiment, a task is assigned to a contiguous part of the terrain when determining the set of at least one point. In addition to capturing at least one image of the ground of the terrain at said point, one or more tasks are associated with the said point. After the autonomous exploration by the unmanned vehicle, these one or more tasks have been assigned to the entire contiguous part within which the said point is located. This embodiment is advantageous because, after the autonomous exploration by the unmanned autonomous vehicle, at least one task is automatically assigned to each of the contiguous areas.

According to an embodiment, after the map of the work zone has been created, a task is assigned to each of the autonomously explored contiguous parts within the work zone. Preferably, the work zone map is displayed as a digital map. The various contiguous parts within the work zone are preferably indicated on said digital map. A contiguous part of the terrain is selected on the digital map, after which a task is assigned to the selected contiguous part of the terrain. This embodiment is advantageous for easily assigning tasks to each of the contiguous parts of the terrain within the work zone.

It will be apparent that this embodiment and a previously described embodiment in which a task is assigned to a contiguous part of the terrain when determining the set of at least one point can be combined with each other. For example, an initial task could be assigned to a contiguous part when determining the set of at least one point and then changed with the current embodiment.

In a second aspect, the invention relates to an unmanned autonomous vehicle for performing tasks on a terrain.

According to a preferred embodiment, the unmanned autonomous vehicle comprises a drive unit for moving the unmanned autonomous vehicle across the terrain, a camera for capturing images of grounds of the terrain, a positioning means for determining a position of the unmanned autonomous vehicle on the terrain and a memory and processor.

The drive unit comprises at least one wheel and a motor for driving the wheel. Preferably, the motor is an electric motor. Preferably, the unmanned autonomous vehicle comprises a battery for powering the motor and other electrical systems. It will be apparent to one skilled in the art that the unmanned autonomous vehicle may comprise two, three, four or more wheels, wherein at least one wheel, preferably at least two wheels, are coupled to the motor for driving. It will be apparent to one skilled in the art that the at least one wheel can be part of a caterpillar track, the caterpillar track being drivable by the motor by means of the at least one wheel. The unmanned autonomous vehicle comprises a steering device for steering the unmanned autonomous vehicle. The steering device is a conventional steering device in which at least one wheel is rotatably arranged. Alternatively, the steering device is part of the drive unit, wherein two wheels on opposite sides of the unmanned autonomous vehicle can be driven differently by the motor. Differently means with a different speed and/or opposite direction of rotation. The steering device may or may not be part of the drive unit.

The camera is a digital camera. The camera is at least suitable for taking two-dimensional images. Optionally, the camera is suitable for taking three-dimensional images, with or without depth determination. The camera has a field of view that comprises at least a part of a ground of the terrain at a distance of at most 2 m from the unmanned autonomous vehicle, preferably at most 1 m, more preferably at most 0.5 m. This is advantageous for determining a classification of a ground type of a ground of the terrain at a position of the unmanned autonomous vehicle in the terrain. The camera has a known alignment on the unmanned autonomous vehicle, the alignment being preferably in a direction of forward movement of the unmanned autonomous vehicle. This is advantageous because during forward movement, the ground of the terrain towards which the unmanned autonomous vehicle is moving falls into the field of view of the camera. Optionally, the unmanned autonomous vehicle comprises a second camera of known alignment, the alignment of the camera preferably being in a direction of backward movement of the unmanned autonomous vehicle. This is advantageous because during backward movement, the ground of the terrain towards which the unmanned autonomous vehicle is moving falls into the field of view of the second camera. Alternatively, the camera is arranged rotatably. This is advantageous because, due to the rotation of the camera, both during forward and backward movement, the ground of the terrain towards which the unmanned autonomous vehicle is moving falls within the camera's field of view, while only a single camera is required. Optionally, the camera is also suitable for capturing images with non-visible light, such as infrared light or ultraviolet light. This is advantageous because it allows images of the terrain to be captured with visible light, infrared light, and ultraviolet light, from which different information can be obtained, which can be advantageously combined for a successful classification of a ground type of a ground of the terrain visible in a captured image. It will be apparent to one skilled in the art that instead of a single camera, various cameras can also be combined, for example, wherein a first camera captures images using visible light, a second camera captures images using infrared light, and a third camera captures images using ultraviolet light. Preferably, the first camera, the second camera, and the third camera have an overlapping field of view. This is advantageous for combining information from images captured using the first camera, the second camera, and the third camera. It will be apparent to one skilled in the art that the unmanned autonomous vehicle can comprise several similar cameras.

The positioning means for determining the position of the unmanned autonomous vehicle can be any suitable means. The positioning means is, for example, a Global Navigation Satellite System (GNSS), such as GPS, GLONASS or Galileo. The positioning means is, for example, a system with wireless beacons on the terrain, whereby the unmanned autonomous vehicle determines a position on the terrain by triangulation. The positioning means is, for example, based on recognition of reference points in images of the terrain, for example images made with the aid of the camera of the unmanned autonomous vehicle. In the latter case, in addition to a known alignment, the camera also has a known position and viewing angle. Knowing the viewing angle of the camera and the position and the alignment of the camera on the unmanned autonomous vehicle, it is possible by means of trigonometry and/or photogrammetry to automatically estimate a distance from a reference point in an image to the camera and the unmanned autonomous vehicle, a distance between two reference points in an image and/or a dimension of a reference point in an image, even if the camera is only suitable for taking two-dimensional images, so that the position of the unmanned autonomous vehicle on the terrain can be determined. In the case of a rotatable camera, the camera is preferably rotatable 360° in a horizontal plane and rotatable 180° in a vertical plane. The rotatable arrangement of the camera is preferably drivably coupled to motors with encoders. Motors with encoders are advantageous for knowing the position and alignment of a rotatably mounted camera.

Non-limiting examples of tasks that can be performed on terrain by the unmanned autonomous vehicle are mowing, vacuuming, sweeping, spraying, pruning, etc. The unmanned autonomous vehicle comprises a memory and a processor. The processor is configured to perform a method according to the first aspect. The memory comprises a working memory and a non-volatile memory.

Such an unmanned autonomous vehicle is advantageous because, after minimal effort by a user of the unmanned autonomous vehicle and without the use of infrastructural boundaries, it is suitable for determining a work zone for the unmanned autonomous vehicle in a terrain, after which the unmanned autonomous vehicle can autonomously perform tasks within the work zone.

According to a preferred embodiment, the camera of the unmanned autonomous vehicle is only capable of taking two-dimensional images. Preferably, only one camera for two-dimensional images is mounted on the unmanned autonomous vehicle. Preferably, the unmanned autonomous vehicle does not comprise lasers, ultrasound transceivers, radars, or other suitable means for measuring distances from the unmanned autonomous vehicle to an object on the terrain.

This embodiment is particularly advantageous because it results in a very simple unmanned autonomous vehicle for performing tasks on a terrain.

In a third aspect, the invention relates to a use of a method according to the first aspect and/or an unmanned autonomous vehicle according to the second aspect for autonomously maintaining a garden.

This use results in a simplified determination of a work zone for an unmanned autonomous vehicle in a terrain, where a user of the unmanned autonomous vehicle determines a part of the terrain as work zone with minimal effort and without using infrastructural boundaries, allowing the unmanned autonomous vehicle to autonomously maintain the garden within the work zone.

One skilled in the art will appreciate that a method according to the first aspect is preferably performed with an unmanned autonomous vehicle according to the second aspect and that an unmanned autonomous vehicle according to the second aspect is preferably configured for performing a method according to the first aspect. Each feature described in this document, both above and below, can therefore relate to any of the three aspects of the present invention.

In what follows, the invention is described by way of non-limiting figures illustrating the invention, and which are not intended to and should not be interpreted as limiting the scope of the invention.

### DESCRIPTION OF THE FIGURES

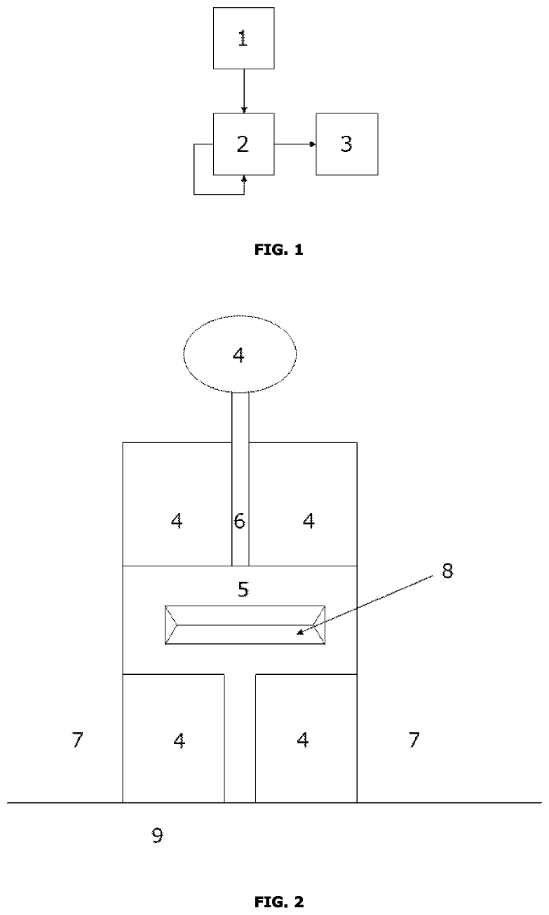

FIG. 1 shows a block diagram of a method according to an embodiment of the present invention.

When performing the method, a work zone for an unmanned autonomous vehicle is determined in a terrain. In a first step (1) of the method, a set of at least one point is determined. Each point in the set is located within the work zone to be determined in the terrain. For each point in the set, at least one image of a ground of the terrain at the said point is captured and classifications of the grounds in the captured images are determined. In a second step (2), the unmanned autonomous vehicle autonomously explores a contiguous part of the terrain. The unmanned autonomous vehicle departs from a point from the set of at least one point determined in the first step (1). The point is within the contiguous part of the terrain. The unmanned autonomous vehicle remains within a perimeter of the contiguous part of the terrain.

The unmanned autonomous vehicle considers an obstacle or a transition to a ground type, which is different from the ground type for the ground at the said point, as part of the perimeter of the contiguous part of the terrain. During the second step (2), the unmanned autonomous vehicle determines, with the aid of a positioning means comprised in the unmanned autonomous vehicle, a position of the unmanned autonomous vehicle on the terrain. The second step (2) is repeated for a next point from the set of at least one point from the first step (1), where the next point is not located in a contiguous part of the terrain that has already been explored autonomously. After all points from the set of at least one point from the first step (1) lie in a contiguous part of the terrain that has been autonomously explored in the second step (2) of the method, a third step (3) is carried out. In this third step, a map of the work zone is created based on the determined positions of the unmanned autonomous vehicle in the second step (2). The work zone corresponds to the autonomously explored contiguous parts of the terrain.

FIG. 2 shows a schematic representation of a terrain with various contiguous parts.

A house (8) has been built on the terrain. The terrain borders a street (9). There is arable land around the terrain (7). There is paved surface (5) around the house (8). The paved surface (5) forms a terrace and a driveway from the street (9) to the house (8). On the side of the street (9), on both sides of the driveway, part of the paved surface (5) is a lawn (4). There are also two lawns (4) at the rear of the house (8). The two lawns (4) at the rear of the house (8) are separated by a path (6). The path (6) leads to a lawn (4) that lies in the arable land (7).

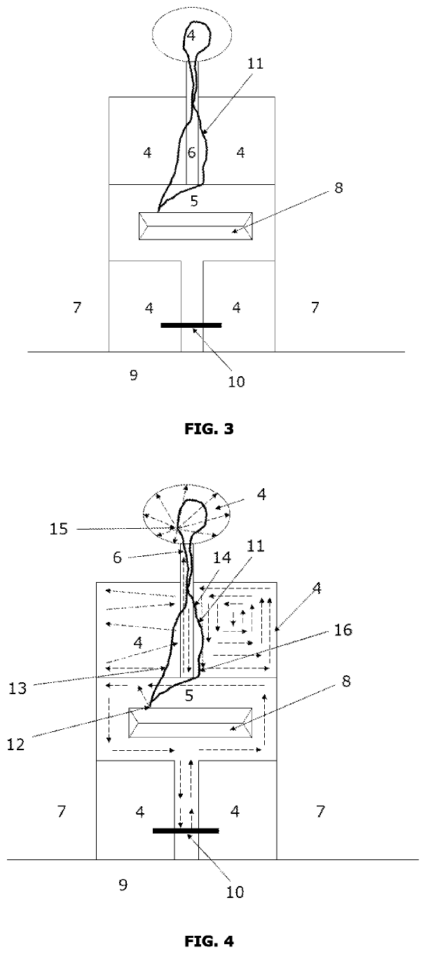

FIG. 3 shows a schematic representation of determining a set of points within a work zone in a terrain with various contiguous parts, according to an embodiment of the current invention.

The terrain corresponds to the terrain in FIG. 2. Determining a set of points within the work zone corresponds to the first step (1) of the method in FIG. 1. A user wishes to define a work zone for an unmanned autonomous vehicle. The user intends to have the unmanned autonomous vehicle maintain the lawns (4) at the back of the house (8) and the lawn (4) in the arable land (7). This may mean, for example, that the unmanned autonomous vehicle clears leaves and mows on said lawns (4). The user also wants the unmanned autonomous vehicle to sweep the paved surface (5) and clear leaves on the path (6). The user does not want the unmanned autonomous vehicle to sweep the paved surface (5) up to the street (9), because the paved surface (5) is occasionally used there by motorists to turn around. The work zone therefore corresponds to several contiguous parts of the terrain, namely the lawn (4) in the arable land (7), the lawns (4) behind the house (8), the path (6) and the paved surface (5). To determine the work zone, the user determines a set of points, with at least one point in each contiguous part belonging to the work zone. To this end, the user moves the unmanned autonomous vehicle along a closed route (11) that starts and ends at a charging station for the unmanned autonomous vehicle on the paved surface (5) at the rear of the house (8). The movement of the unmanned autonomous vehicle takes place, for example, because the unmanned autonomous vehicle follows the user along the closed route (11). The user moves the unmanned autonomous vehicle from the paved surface (5) to the lawn (4) on the left behind the house (8) and then via the path (6) to the lawn (4) in the arable land (7), the path (6) again and the lawn (4) on the right behind the house, to return to the charging station on the paved surface (5). While the unmanned autonomous vehicle is moving along the closed route, points are added to the set of at least one point by determining a position of the unmanned autonomous vehicle on the terrain using the positioning means comprised in the unmanned autonomous vehicle and simultaneously using a camera of the unmanned autonomous vehicle to record at least one image of a ground of the terrain at the said position. In an additional step of the method, the user of the unmanned autonomous vehicle determines a coordinate of a first end point and a coordinate of a second end point. The coordinates of the first end point and the second end point are determined, for example, by drawing a line on a digital map of the terrain. The first end point and the second end point define a line (10) that is considered part of a perimeter of the contiguous part by the unmanned autonomous vehicle during the second step (2) of the method of FIG. 1. In this case, the contiguous part is the part of the paved surface (5) that belongs to the work zone to be determined.

FIG. 4 shows a schematic representation of the autonomous exploration of a terrain with various contiguous parts, according to an embodiment of the current invention.

The terrain corresponds to the terrain in FIG. 3. The autonomous exploration of various contiguous parts of the terrain corresponds to the second step (2) of the method in FIG. 1. The unmanned autonomous vehicle departs from a first point (12) from the set of at least one point. The first point (12) is located in a contiguous part of the terrain that is formed by part of the paved surface (5). In this example, the autonomous exploration of the paved surface (5) takes place by autonomously driving the unmanned autonomous vehicle along a perimeter of the paved surface (5). The perimeter in this case is formed by a transition to arable land (7), lawn (4) or path (6), by an obstacle in the form of the house (8) and by the line (10) defined by the user. A transition to a different ground type than the paved surface (5) is determined with the aid of a camera comprised in the unmanned autonomous vehicle. In this example, the positioning means is the camera of the unmanned autonomous vehicle. If the viewing angle of the camera is sufficiently wide, driving the unmanned autonomous vehicle along the perimeter of the contiguous part formed by part of the paved surface (5) can suffice to fully explore this part. After the contiguous part of the terrain formed by part of the paved surface (5) has been autonomously and completely explored by the unmanned autonomous vehicle, in this example the lawn (4) behind the house (8) on the left is autonomously explored from a second point (13) from the set of at least one point. The second point (13) is in the lawn (4) left behind the house (8). To this end, the unmanned autonomous vehicle autonomously moves to the second point (13). To illustrate possible patterns for autonomous exploration of a contiguous part of the terrain, the unmanned autonomous vehicle drives in a zigzag pattern each time up to a perimeter through the lawn (4) on the left behind the house (8). In this case, the perimeter is formed by a transition from said lawn (4) to the paved surface (5), the path (6) and the arable land (7). Subsequently, the unmanned autonomous vehicle moves autonomously to a third point (14) from the set of at least one point, from where the contiguous part formed by the path (6) is autonomously explored. Again, to illustrate possible patterns for autonomously exploring a contiguous part of the terrain, the unmanned autonomous vehicle drives down the path (6) in two opposite directions. A perimeter of this contiguous part is formed by a transition from the path (6) to the paved surface (5), the lawn (4) behind the house (8) on the left, the lawn (4) on the right behind the house (8), the arable land (7) and the lawn (4) in the arable land (7). After this, the unmanned autonomous vehicle moves to a fourth point (15) from the set of at least one point. The fourth point (15) is in the lawn (4) in the arable land (7). This is the next contiguous part of the terrain that will be explored autonomously by the unmanned autonomous vehicle. Again, to illustrate possible patterns for autonomous exploration of a contiguous part of the terrain, the unmanned autonomous vehicle travels in a different direction each time from the fourth point (15) up to a perimeter of the contiguous part. In this case, the perimeter is formed by a transition from lawn (4) to arable land (7) and path (6). Finally, the unmanned autonomous vehicle moves to a fifth point (16) which is located in the lawn (4) on the right behind the house (8). The lawn (4) on the right behind the house (8). This is the last contiguous part of the terrain to be explored autonomously. As a final illustration of possible patterns for autonomous exploration of a contiguous part of the terrain, the unmanned autonomous vehicle drives in a spiral pattern through the lawn (4) on the right behind the house (8), until the entire lawn (4) has been fully explored. The unmanned autonomous vehicle hereby remains within a perimeter for the contiguous part of the terrain formed by a transition from the lawn (4) on the right behind the house (8) to the path (6) and the paved surface (5). After autonomously exploring the lawn (4) on the right behind the house (8), there are no more points on the route (11) that are not located in a contiguous part of the terrain that have not yet been explored autonomously. In this example, the unmanned autonomous vehicle autonomously returns to the charging station on the paved surface (5) behind the house (8) to create a map of the work zone. This corresponds to the third step (3) in FIG. 1. The work zone therefore corresponds to the lawn (4) in the arable land (7), the lawns (4) on the left and right behind the house (8), the path (6) and the terrace around the house and the driveway from the house up to the line (10). The lawns (4) in front of the house (8) are not part of the work zone, as no points of the route (11) are located within these contiguous parts of the terrain.

1. A method for determining a work zone for an unmanned autonomous vehicle in a terrain, wherein the unmanned autonomous vehicle comprises a camera for capturing images of the terrain and a positioning means for determining a position of the unmanned autonomous vehicle on the terrain, the method comprising the steps of:
determining a set of at least one point, each point of the set being located within the work zone to be determined in the terrain, in which, for each point in the set, at least one image of a ground of the terrain at said point is captured and classifications for ground types of the grounds in the captured images are determined;
exploring a contiguous part of the terrain autonomously with the unmanned autonomous vehicle, where the unmanned autonomous vehicle departs from a point in the set of at least one point within the contiguous part of the terrain, wherein the unmanned autonomous vehicle remains within a perimeter of the contiguous part of the terrain, wherein the unmanned autonomous vehicle considers an obstacle or a transition to a ground type which is different from the ground type for the ground at the point from the set of at least one point, as part of the perimeter, wherein the unmanned autonomous vehicle determines a position of the unmanned autonomous vehicle on the terrain with the aid of the positioning means during the autonomous exploration;
repeating the previous step from a next point in the set of at least one point, where the next point is not located in a contiguous part of the terrain that has already been explored autonomously; and
creating a map of the work zone based on the determined positions of the unmanned autonomous vehicle, where the work zone corresponds to the autonomously explored contiguous parts of the terrain.

2. The method according to claim 1, further comprising the additional step of determining a coordinate of a first end point and a coordinate of a second end point, the first end point and the second end point defining a line that is considered part of the perimeter of the contiguous part by the unmanned autonomous vehicle while autonomously exploring a contiguous part of the terrain.

3. The method according to claim 2, wherein the coordinates of the first end point and the second end point are determined by drawing a line on a digital map of the terrain.

4. The method according to claim 1, wherein the the unmanned autonomous vehicle dynamically adjusts the map of the work zone based on identified obstacles and/or based on a changed ground type within the work zone.

5. The method according to claim 1, wherein the unmanned autonomous vehicle determines classifications for ground types of grounds on the terrain with the aid of a neural network.

6. The method according to claim 1, wherein the map of the work zone is created while the unmanned autonomous vehicle is being charged at a charging station.

7. The method according to claim 1, wherein the the set of at least one point is determined by moving the unmanned autonomous vehicle along a route, wherein the unmanned autonomous vehicle is only moved over parts of the terrain that are part of the work zone to be determined, wherein a point is added to the set of at least one point, by using the positioning means to determine a position of the unmanned autonomous vehicle on the terrain and at the same time taking at least one image of a ground of the terrain using the camera of the unmanned autonomous vehicle at the determined position and wherein the unmanned autonomous vehicle automatically adds a point to the set of at least one point at regular intervals.

8. The method according to claim 7, wherein the unmanned autonomous vehicle moves along the route by following a person, wherein the unmanned autonomous vehicle captures images of the person with the camera, wherein the person is recognized in the captured images by using image recognition.

9. The method according to claim 7, wherein the route is a closed route in which the unmanned autonomous vehicle automatically begins the step of autonomous exploration after the route is closed.

10. The method according to claim 7, wherein the unmanned autonomous vehicle creates a map of the route after determining the set of at least one point.

11. The method according to claim 1, wherein the set of at least one point is determined by indicating the at least one point on a digital map of the terrain.

12. The method according to claim 1, wherein the positioning means makes use of a Global Navigation Satellite System.

13. The method according to claim 1, wherein the positioning means uses the camera of the unmanned autonomous vehicle.

14. An unmanned autonomous vehicle for performing tasks on a terrain, comprising:
a drive unit for moving the unmanned autonomous vehicle across the terrain,
a camera for capturing images of grounds of the terrain;
a positioning means for determining a position of the unmanned autonomous vehicle on the terrain; and
a memory and a processor, the processor being configured to perform the following operations:
determining a set of at least one point, each point of the set being located within the work zone to be determined in the terrain, in which, for each point in the set, at least one image of a ground of the terrain at said point is captured and classifications for ground types of the grounds in the captured images are determined;
exploring a contiguous part of the terrain autonomously with the unmanned autonomous vehicle, where the unmanned autonomous vehicle departs from a first point in the set of at least one point within the contiguous part of the terrain, wherein the unmanned autonomous vehicle remains within a perimeter of the contiguous part of the terrain, wherein the unmanned autonomous vehicle considers an obstacle or a transition to a ground type which is different from the ground type for the ground at the first point, as part of the perimeter, wherein the unmanned autonomous vehicle determines a position of the unmanned autonomous vehicle on the terrain with the positioning system during the autonomous exploration;
repeating the previous step from a next point in the set of at least one point, where the next point is not located in the contiguous part of the terrain that has already been explored autonomously; and
creating a map of the work zone based on the determined positions of the unmanned autonomous vehicle, where the work zone corresponds to the autonomously explored parts of the terrain.

15. The unmanned autonomous vehicle according to claim 14, wherein the terrain is a garden and the unmanned autonomous vehicle autonomously maintains the garden.
